(19) United States
(12) Patent Application Publication
(10) Pub. No.: US 2025/0240334 A1
(43) Pub. Date: Jul. 24, 2025

(54) METHODS AND SYSTEMS FOR SMART SCAN IDENTIFICATION OF MEDIA STREAMS

(71) Applicant: TuneIn, Inc., San Francisco, CA (US)

(72) Inventors: Abraham Ben-Tov, San Francisco, CA (US); Sarah Emerson, San Francisco, CA (US); Richard Stern, San Francisco, CA (US); Eric Wilcox, San Francisco, CA (US); Rahat Kukreja, San Francisco, CA (US)

(21) Appl. No.: 19/034,148

(22) Filed: Jan. 22, 2025

Related U.S. Application Data
(60) Provisional application No. 63/623,852, filed on Jan. 23, 2024.

(51) Int. Cl. H04L 65/1069; G06F 16/435; H04L 41/16; H04L 65/1073; H04L 65/611; H04L 65/80

(52) U.S. Cl. CPC H04L 65/1069; G06F 16/435; H04L 41/16; H04L 65/1073; H04L 65/611; H04L 65/80

(57) ABSTRACT

In some aspects, the techniques described herein relate to a computer-implemented method, which may include receiving user data associated with a user profile. The user profile is associated with a user device. The method may also include generating an ordered list of communication channels based on the user profile and receiving, from the user device, a user setting including a duration of time. The method may further include facilitating a connection with a first communication channel of the ordered list of communication channels and outputting media content associated with first communication channel. The method may further include receiving a characteristic associated with the first communication channel and generating a modified ordered list based on the characteristic. The method may further include facilitating a connection with a second communication channel of the ordered list of communication channels.

### CROSS-REFERENCE TO RELATED APPLICATIONS

This application claims priority to and the benefit of U.S. Provisional Application No. 63/623,852, filed Jan. 23, 2024, titled “METHODS AND SYSTEMS FOR SMART SCAN IDENTIFICATION OF MEDIA STREAMS,” the disclosure of which is hereby incorporated by reference in its entirety.

### TECHNICAL FIELD

This disclosure relates generally to smart scan identification, and more particularly to dynamic contextual-based identification of communication channels according to one or more parameters.

### BACKGROUND

Traditional analog radio stations for generic user listening are limited to a specific bandwidth range set by the government. Analog radios may receive transmissions from broadcasting stations within the specific bandwidth range and may output a channel associated with a bandwidth selected by a user. Since the specific bandwidth range is known, the frequencies associated with a broadcast station can be identified by identifying frequencies associated with a high signal to noise ratio. However, identifying particular frequency ranges does not provide an indication of what media is being broadcast by the broadcast station. As broadcasters begin broadcasting over other communication channels (e.g., the Internet), identifying broadcast stations or the media broadcast by particular broadcast stations may be even more difficult and complex.

### SUMMARY

Methods described herein for identifying sequences of communication channels for automatic presentation according to one or more parameters. In some examples, the method may include receiving user data that may be associated with a user profile and associated with a user device. The method may also include generating an ordered list of communication channels based on the user profile and receiving, from the user device, a timer value including a duration of time. The method may further include facilitating a connection with a first communication channel of the ordered list of communication channels and outputting media content associated with first communication channel. The method may further include receiving a characteristic associated with the first communication channel and generating a modified ordered list of communication channels based on the characteristic. The method may further include facilitating a connection with a second communication channel of the modified ordered list of communication channels, where the second communication channel is different from the first communication channel.

In some examples, the method may further includes receiving user input from the user device, wherein the user input causes the output of the media content associated with the second communication channel.

In some examples, the method may further include that the ordered list is generated by a machine-learning model.

In some examples, the method may further include that the machine-learning model generates the ordered list further based on a communication channel history associated with the user device.

In some examples, the method may further include that the user profile comprises at least one of demographic data, communication channel history, or user preferences.

In some examples, the method may further include that the machine-learning model was trained using transfer learning.

In some examples, the method may further include that the first communication channel is associated with media content that is of the same type as media content associated with the second communication channel.

In some examples, the method may further include that an identification of the first communication channel is stored within the user profile.

Systems are described herein for identifying sequences of communication channels for automatic presentation according to one or more parameters. The systems may comprise one or more processors and a memory storing instructions that, as a result of being executed by the one or more processors, cause the system to perform any of the aforementioned methods.

Non-transitory computer-readable storage media are described herein that store instructions therein that, as a result of being executed by one or more processors, cause the one or more processors to perform the any of the aforementioned methods.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### BRIEF DESCRIPTION OF THE DRAWINGS

Features, embodiments, and advantages of the present disclosure are better understood when the following Detailed Description is read with reference to the accompanying drawings.

FIG. 1 illustrates an example schematic diagram for smart scan identification, according to aspects of the present disclosure.

FIG. 2 illustrates an example computing environment for a user device performing smart scan identification using machine-learning techniques according to aspects of the present disclosure.

FIG. 3 illustrates an example computing environment for a content-provider system performing smart scan identification using machine-learning techniques according to aspects of the present disclosure.

FIG. 4 illustrates an example computing environment for a content-provider system performing smart scan identification based on output generated from a special-purpose computer according to aspects of the present disclosure.

FIG. 5 illustrates an example process for smart scan identification using machine-learning techniques according to aspects of the present disclosure.

FIG. 6 shows a computing system architecture, including various components in electrical communication with each other, according to aspects of the present disclosure.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Systems and methods are described herein for dynamic contextual-based identification of communication channels using machine-learning techniques. A user device may obtain access to an associated application capable of performing the systems and methods discussed herein. In some examples, the user device may use a downloaded mobile application, a website, web service, an API, and/or any other mechanism capable of streaming communication channels. The user device may transmit a request to the application to initiate a smart scan session. The application may receive data including, but not limited to, user device data, user profile data (associated with one or more users of the user device), demographic data, localized data, historical data, any combination thereof, or the like. The application may, using the one data, generate an ordered list of one or more communication channels. The one or more communication channels of the ordered list may be in a random order (e.g., ordered via a random number generator and/or a hash algorithm) or may be ranked according to one or more variables. For example, if the user was most recently streaming a communication channel associated with country music, other communication channels of the ordered list associated with country music may be ranked higher on the ordered list. In some examples, a value (e.g., a “relevance value,” a popularity value, etc.) may be associated with each of the one or more communication channels of the ordered list and the one or more communication channels may be placed in the ordered list according to the associated value. The communication channels may represent live broadcasts of media originating from varying locations (e.g., such as, but not limited to, geographic locations, network locations, memory locations, and/or the like). In some examples, the ordered list may be generated by one or more machine-learning models trained to identify trends in data and identify communication channels relevant to the user device.

The user device may also output one or more user parameters associated with the smart scan session. The one or more user parameters be associated with the connection between the user device and a communication channel and/or the presentation of media of a communication channel such as, but not limited to, a duration of time for sampling the communication channels, an identification of a content type currently being presented by a communication channel, an identification of content to be presented during a smart scan session, a quantity of communication channels to be included in the ordered list, any combination thereof, or the like. In some examples, the one or more user parameters may change according to the communication channel. For example, the duration of time for sampling the communication channels may change depending on the content type currently being presented by the communication channel (e.g., sample musical content longer than talk radio content, skip over channels currently broadcasting a commercial, etc.). The application associated with the user device may output media content associated with a first communication channel of the ordered list via an audio output device (e.g., speaker of the user device, a speaker connected to the user device via a wireless connection, a speaker connected to the user device via a wired connection, wireless headphones, wired headphones, etc.). The application may output the media content for the duration of time indicated by the one or more user parameters. After the duration of time, the application may automatically output media content associated with a second communication channel of the ordered list. The application may output subsequent communication channels in a similar fashion until receipt of additional input from the user device.

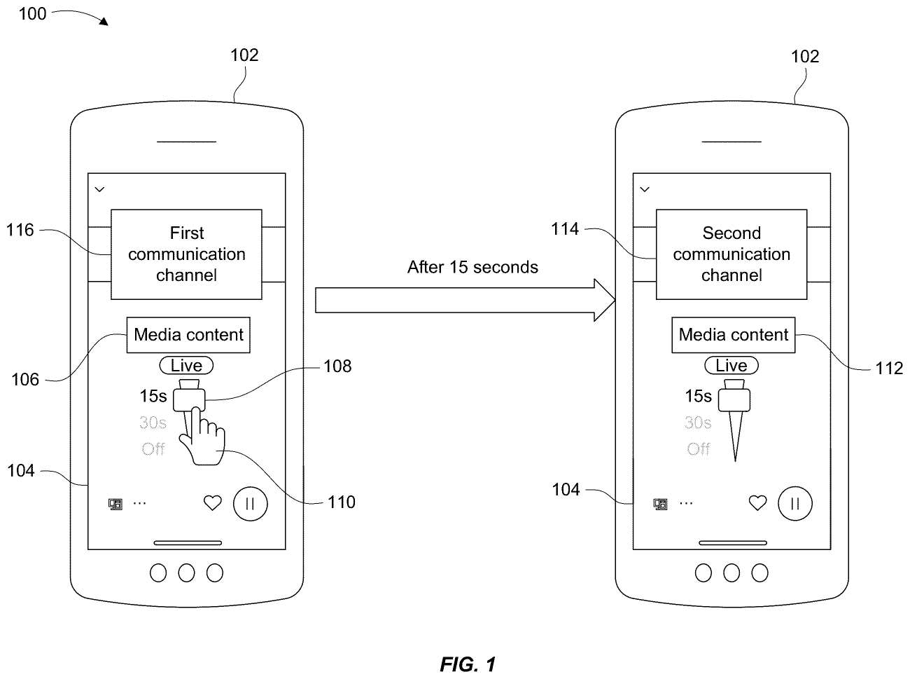

FIG. 1 illustrates an example schematic diagram 100 for smart scan identification of media streams, according to some embodiments. A user device 102 may execute a media-streaming application configured to connect to communication channels and present media being broadcast over the communication channels. A communication channel may be a medium over which media (e.g., audio, video, and/or the like) can be broadcast to one or more devices. Examples of communication channels can include, but are not limited to, broadcast radio (e.g., Amplitude Modulation (AM), Frequency Modulation (FM), Digital Audio Broadcasting (DAB), High-Definition HD radio, Digital Radio Mondiale (DRM), etc.), broadcast television, media streams (e.g., via the Internet, a webservice, cloud service, one or more remote devices, etc.), combinations thereof, or the like. The media-streaming application may present a user interface 104 usable to establish connections with communication channels, manage connections with communication channels, terminate connections with communication channels, facilitate the presentation of media content 106, etc.

As an illustrative example, the media-streaming application can stream music broadcasted by a classical music radio station in New York. A user can interact with the user interface 104 to manage the presentation of the music broadcasted from the New York classical music radio station (e.g., play, pause, terminate, etc.). In some instances, the user can interact with the user interface 104 to select another communication channel to stream different media content. The examples presented in FIG. 1 provides the user device 102 streaming music content, but the user device 102 can also be configured to provide other types of media content including video, video games, virtual reality, augmented reality, and the like.

In some examples, the media-streaming application may initiate a smart scan session. A smart scan session may facilitate a sequence of a connections with communication channels to enable an identification of the communication channels and/or identify media to be presented by the user device 102. The media-streaming application may generate an ordered list of communication channels defined from one or more of a list of known communication channels, a set of known Internet Protocol or Media Access Control address associated with communication channels, a of Internet Protocol or Media Access Control address (e.g., randomly generated, etc.), one or more electromagnetic frequencies associated with known communication channels, a range of electromagnetic frequencies, combinations thereof, or the like. The list of communication channels may be ordered based on one or more characteristics of user device 102 and/or the user thereof, historical data associated with user device 102 or the music-streaming application, or the like.

The media-streaming application may include parameters configured to control the operations of the smart scan session. For instance, the user interface 104 may include a first parameters such as a timer element 108. The timer element 108 defines a duration of timer that controls the connection to each communication channel of the ordered list of communication channels. The timer may be initiated when the media-streaming application connects to a first communication channel 114. The expiration of the timer may cause the media-streaming application to establish a connection with a second communication channel 116 of the ordered list of communication channels. For example, timer element 108 may be configured to 15 seconds (as shown). When the timer expires, the media-streaming application terminates the connection with the first communication channel 114 and establishes the connection with the second communication channel 116.

In some examples, the timer element 108 can incorporate a slider feature (e.g., vertical as shown, horizontal, or other orientation), in which the user can slide the timer element 108 to modify the time length from any minimum length (e.g., 0, etc.) to any maximum length (e.g., 30 seconds as shown, 1 minute, 5 minutes, or any other duration of time). The timer element 108 may include other representations within user interface 104 such as, but not limited to, one or more selectable objects or buttons corresponding to preset timer values, a text field configured to receive a numerical time value, etc. The length of time may be set by the media-streaming application (e.g., by timer element 108), user input (e.g., via a setting or media streaming application), machine-learning models, combinations thereof, or the like and is not limited to 15 seconds, 30 seconds, and “off,” as shown in FIG. 1. In some instances, the timer element 108 may define a static timer in which the timer instantiated each time the media-streaming device connects to a new communication channel may be of a same duration. In other instances, the timer element 108 may define a dynamic timer based on one or more characteristics of the user device 102, the media-streaming application, the current communication channel, the next communication channel, the user, historical communication channels selected by the user, user input, and/or the like. For example, upon connecting to the first communication channel, the media-streaming application may determine that media presented by the first communication channel does not correspond to a particular media type. The media-streaming application may cause the timer element 108 to shorten the timer to cause the media-streaming application to switch to the next communication channel (e.g., immediately or within a shortened time interval).

In some examples, the timer element 108 may be configured to be “off,” which may indicate that the media-streaming application output the current communication channel and/or media content until receipt of additional input from user device 102. For example, if the timer element 108 is set to “off,” the media-streaming application outputs the media content 106 associated with the first communication channel 114 until the user device 102 receives input from the associated user, such as a selection of a “skip” button, a swipe on a touchscreen, a verbal command, any combination thereof, or the like.

The media-streaming application may include one or more parameters that configure the smart scan session that include, but are not limited to, the timer element 108. For example, the media-streaming application may include parameters for configuring dynamic timers, identifying communication channels to include in the ordered list of communication channels, defining the order of communication channels for the ordered list of communication channels, combinations thereof, or the like.

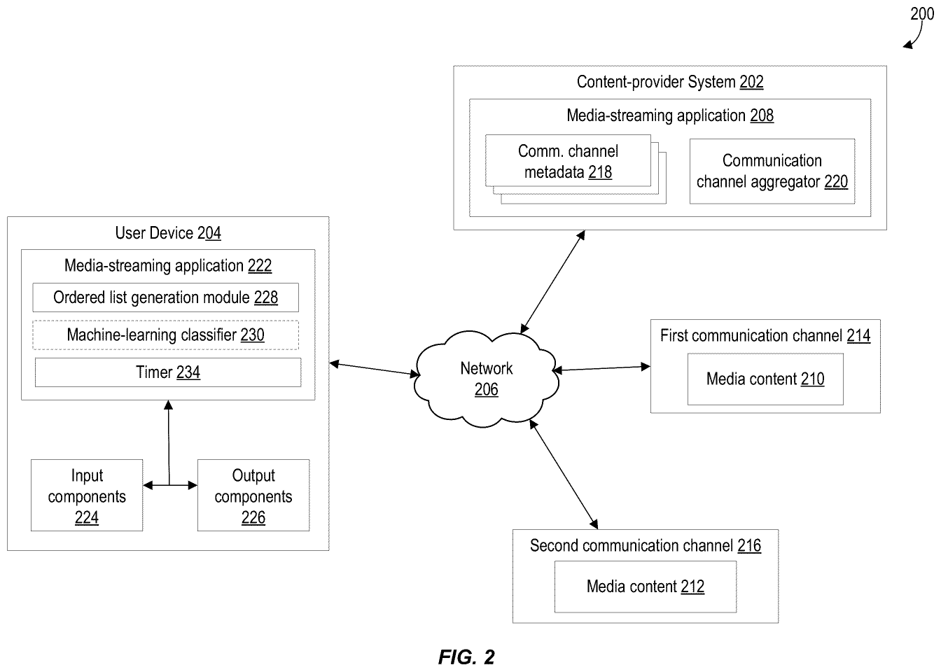

FIG. 2 illustrates an example computing environment 200 for a user device predicting interruptions in media content using machine-learning techniques, according to some embodiments. In FIG. 2, a content-provider system 202 may include hardware and/or software components that operate within a distributed environment to stream media content to one or more user devices (e.g., a user device 204) over a communication network 206. The content-provider system 202 can store and execute a server-side media-streaming application 208, which may be configured to stream media content 210 and 212 broadcasted from various communication channels (e.g., first communication channel 214 and second communication channel 216). To facilitate streaming of media content, the server-side media-streaming application 208 can access various data from the user device 204 (e.g., a computing device, an in-vehicle entertainment system, a mobile device, or the like). For example, the media-streaming application 208 can access past browsing history (e.g., web-browsing history, media-streaming application browsing history, historical communication channels accessed by the media streaming application, etc.) of the user device 204 and user profile data of the user device 204 to identify a set of default communication channels for streaming media content to the user device 204. In some instances, when operating in a distributed environment, the content-provider system 202 may include executable processes in which some processes may be executed by the user device 204 and some processes may be executed by the content-provider system 202.

The media-streaming application 208 may receive media streams corresponding to first communication channel 214 and second communication channel 216 (e.g., such as, but not limited to a radio broadcast) over the network 206 (e.g., a cloud network, a local area network, a wide area network, the Internet, etc.). The media streams may be transmitted or broadcasted by first communication channel 214 and second communication channel 216 (e.g., physical location from which a media stream is broadcasted or transmitted such as, but not limited to, a radio station). The media-streaming application 208 can process the media streams to present the corresponding media content to the user device 204. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 202 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 208. The content-provider system 202 can also include one or more databases that store communication channel metadata 218 that include data for identifying media content broadcasted by a communication channel, a genre of the media content, a program schedule of content included in the media content, location of the communication channel, and/or the like.

In some instances, a communication channel aggregator 220 stores groups of communication channels that provide substantially similar media content. For example, the communication channel aggregator 220 stores a first group of communication channels that provide sports-news content, a second group of communication channels that provide classical-rock content, and the like. As the user device 204 selects a particular communication channel provided by the media-streaming application 208, a corresponding group of communication channels are presented together to allow the user to switch between different communication channels to access similar media content. The association between the communication channels can be predetermined by the content provider based on historical data from users that utilize the media-streaming application, locations at which the communication channels are broadcasted, etc. In some instances, the communication channels are grouped together by analyzing the respective metadata of the media streams. For example, the metadata from a particular media stream can identify that the communication channel is a classical music radio station based on San Francisco, which can be grouped with a communication channel in New York that broadcasts classical music.

The user device 204 can also include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 202 and present the media stream to provide media content for a user. The user device 204 also include a client-side media-streaming application 222, input components 224, and output components 226. The media-streaming application 222 can be configured to facilitate smart scan sessions and generate an ordered list of one or more communication channels customized to the user device. To enable user interaction with the media-streaming application 222, the input components 224 can be utilized, which can include a microphone for speech, a touch-sensitive screen for gesture or graphical input, keyboard, mouse, motion input, pen, and other such input devices. In addition, the media content from communication channels can be output using the output components 226, which can include, but not limited to, monitors, speakers, printers, haptic devices, and other such output devices.

In some instances, the user device 204 interacts with the media-streaming application 222 through a user interface to identify communication channels and access their respective media streams. The user interface may display one or more user interface elements that identify the media content presented, being presented, and/or to be presented by the user device (e.g., media content 210), as well as the communication channel corresponding to the media content (e.g., first communication channel 214). The user input may be received using the input components 224 to select an icon that represents a communication channel, which triggers the media content to be presented on the user device 204 via the output components 226 (e.g., speaker, display screen).

The media-streaming application 222 can include an ordered-list generation module 228, a machine-learning classifier 230, and a timer 234, which can be used individually or in combination to facilitate smart scan sessions. For example, the ordered-list generation module 228 can generate an ordered list of one or more communication channels. The ordered list may contain the first communication channel 214 and the second communication channel 216 and their respective media content (e.g., media content 210 and media content 212). The media content (e.g., media content 210 and media content 212) may be transmitted by a network (e.g., network 206) via a respective media stream. The respective media stream may be associated with a communication channel. The respective media stream associated with the media content 210 and 212 may be transmitted by the network 206 to the media-streaming application 222 for output by the user device 204. The media stream may include audio and/or visual content. As an illustrative example, the media-streaming application 222 can be installed in the user device, in which the media-streaming application 222 provides an interface that facilitates streaming of music broadcasted by a classical music radio station in New York. The media-streaming application 222 can access a media stream of media content 110 as the music is being broadcasted from the first communication channel 214 to the user device 204. The timer 234 defines a duration of time (e.g., seconds, minutes, hours, etc.) that controls the connection to each communication channel of the ordered list of communication channels. The timer may be initiated when the media-streaming application 222 connects to the first communication channel 214. The expiration of the timer may cause the media-streaming application to establish a connection with a second communication channel 216 of the ordered list of one or more communication channels.

The ordered-list generation module 228 can generate a list of one or more communication channels (e.g., first communication channel 214 and/or second communication channel 216) based on a set of data. The set of data may be associated with user device 204, and may include, but is not limited to, a user profile (e.g., demographic information, user preferences, age, geographic location, etc. of a user associated with the user device 204), registered geolocation of the user device 204, current geolocation of the user device 204, geolocation of a broadcasting center associated with a communication channel, a communication channel history (e.g., listening frequency, listening habits, communication channel preferences, genre preferences, etc.), indications of one or more communication channels saved to the user profile (e.g., “saved” or “favorited” communication channels), popular communication channels (e.g., popular for a particular, age, region, genre, etc.), communication channel metadata 218, communication channel aggregator 220, any combination thereof, or the like. In some examples, the ordered-list generation module 228 may select one or more communication channels according to the set of data. For example, the ordered-list generation module 228 may select one or more communication channels with a highest degree of similarity to the communication channel history, indications of one or more communication channels saved to the user profile, communication channels popular with a particular demographic or geographic region, etc. Similarity may be determined by matching characteristics of the selected communication channel (e.g., genre, artists, subject matter, broadcast location, etc.) to corresponding characteristics of communication channels stored in the channel history of a user device. A high degree of similarity may correspond with a predetermined quantity of matching characteristics. For example, if the user device frequently outputs communication channels associated with political talk radio, the ordered-list generation module 228 may select communication channels associated with political talk radio to input into the ordered list.

In some instances, the ordered-list generation module 228 can generate the list of one or more communication channels using a machine-learning classifier 230. The machine-learning classifier 230 may receive the set of data and may be trained to generate a list of one or more communication channels customized to the user device 204 using a first machine-learning model. Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. In some instances, the first machine-learning model may be trained using training data received and/or derived from media streams previously presented by the user device 204. In some examples, the first machine-learning model may be trained using training data received and/or derived from prior lists of one or more communication channels. In some instances, the first machine-learning model may be trained using media streams associated other user devices (e.g., such as other devices executing the media-streaming application). The first machine-learning model can be trained using supervised training, supervised training, semi-supervised training, reinforcement training, combinations thereof, or the like.

For example, the first machine-learning model may be trained using transfer learning. Transfer learning is a technique in machine learning where a machine-learning model initially trained to solve a particular task is used as the starting point for a different task. Transfer learning can be useful when the second task is somewhat similar to the first task, or when there is limited training data available for the second task. For example, a machine-learning model initially trained to generate a list of similar communication channels may be further trained to generate a list of communication channels customized for a particular user device. In some instances, the machine-learning classifier 230 may access a pre-trained model and “fine-tune” the pre-trained model by training the pre-trained model on a second training dataset. The second training dataset can include training data that are labeled as either corresponding to musical content or non-musical content (e.g., talk radio, advertisements, etc.). To further fine-tune the first machine-learning model, the machine-learning classifier 230 reconfigures the first machine-learning model to include additional hidden and/or output layers to recognize musical and/or non-musical content and dynamically adapting the timer 234 (e.g., playing a longer sample of talk radio and a shorter sample of musical radio before switching to the next communication channel). In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the first machine-learning model can include freezing the weights of the first machine-learning model, to train the first machine-learning model to predict interruptions in the media content. Then, the weights can be unfrozen such that the first machine-learning model can be trained to improve accuracy of the classification.

The machine-learning classifier 230 can also be configured to apply the first machine-learning model to the list of one or more communication channels to modify the list in real-time according to received user input (e.g., if the user continues to skip country music stations, the machine-learning model may remove country music stations from the list of one or more communication channels) or the properties of the user device 204 or the user thereof (e.g., such as, but not limited to, a real-time geolocation of the user device, etc.). In particular, the list of one or more communication channels may be updated in real-time as input is received by media-streaming application 222 through the user device 204.

The media stream can additionally include other types of data. For example, the media stream can include metadata for use in identifying the media content 210 and/or the first communication channel 214. The metadata may include, but is not limited to, an identification of a genre of the communication channel and/or current media content being presented, an identification of a song, an identification of an artist, an identification of an album, an identification of a media presentation (e.g., a concert, television show, movie, etc.), an identification of historical media streams (e.g., within a predetermined time interval such as past day, year, etc. or with any time interval), a communication channel (e.g., radio station), a location (e.g., a country, a state, a region, a city, an address, etc.), a context (e.g., such as a concept, emotion, an experience, and/or the like), or the like. In some examples, the media-streaming application 222 may identify the type of media content included in the media stream. For example, the media-streaming application 222 may identify that a communication channel is streaming a song, a talk-radio program, a local and/or national news program, an advertisement and/or commercial, a morning talk radio program, a sports talk program, a sporting event, a political program, a stream of a live event (e.g., the State of the Union Address, the Oscars, a live sporting event, etc.), etc.

In some examples, the media-streaming application 222 may request the machine-learning classifier 230 identify the type of media included in the media stream and/or the media content (e.g., an identifier of a particular song, live event, program, etc.). A second machine-learning model may be trained to identify media associated with a media stream. In some instances, the second machine-learning model may use natural language interpretation to match words or phrases of media of broadcast channel to words and phrases stored in a reference database of known media. Alternatively, or additionally, the second machine-learning model may use frequency analysis, spectral analysis, pattern matching, and/or the like to match media of a broadcast channel to segments of media stored in a reference database of known media. The second machine-learning model may be trained in a manner similar to the first machine-learning model. In some examples, the first machine-learning model and the second machine-learning model may operate in conjunction with one another to implement commands from the machine-learning classifier 230 and/or the media-streaming application 222. The second machine-learning model may receive data, including, but not limited to, the metadata associated with the media stream mentioned above, data pertaining to the associated communication channel (e.g., location of the station, description associated with the communication channel, schedule associated with media content to be streamed on the communication channel, name of the communication channel, etc.), the media content associated with the media stream (e.g., audio and/or visual content), any combination thereof, or the like.

The media-streaming application 222 may present the media content associated with a communication channel in the list of one or more communication channels via user device 204. For example, the media-streaming application 222 may present the media content 210 from the first communication channel 214. Upon presentation, the media-streaming application 222 may initiate the timer 234. When the timer 234 expires, the media-streaming application 222 may begin presentation of the second communication channel 216 and associated media content 212. The timer 234 can be deactivated at any time via user input to prevent the media-streaming application from changing communication channels or causing the media-streaming application to switch to the next communication channel early (e.g., before termination of the timer 234). For example, the user can “skip” the first communication channel 214 if the user dislikes the media content 210 and may cause the second communication channel 216 to automatically be presented, regardless of the status of the timer 234. If the user opts to manually switch communication channels, the timer 234 may automatically reset upon presentation of a new communication channel. In some instances, the length of the timer may be configured by user input, the media-streaming application (e.g., based on default settings, historical user input, etc.), a machine-learning model, and/or the like prior to activation of the timer 234. The length of the timer may be any length of time such as, but not limited to, seconds, minutes, hours, etc.

In some examples, the media-streaming application 222 may present the communication channels of the list of the one or more communication channels in sequential order. In some examples, the media-streaming application 222 may select the communication channels of the list of the one or more communication channels for presentation randomly (e.g., using a random number generator, a hash algorithm, etc.). The machine-learning classifier 230 may dynamically modify the list of the one or more communication channels in real-time according to feedback from the user device 204. The machine-learning classifier 230 may add communication channels, remove communication channels, modify the order of communication channels, modify the timer 234, etc. according to input and/or feedback from the user device 204. For example, the machine-learning classifier 230 may detect that the user device 204 is presenting communication channels playing pop for longer durations (e.g., manually skipping all other genres of communication channels) and may modify the list of the one or more communication channels by adding additional pop-genre communication channels and/or removing communication channels associated with other genres (e.g., country, rock, electronic, etc.). In some examples, the machine-learning classifier 230 may recognize the type of content of media content 210 (e.g., talk radio, music radio, long-format programming, etc.) and may modify the timer 234 automatically. For example, the media content 210 may be a morning talk radio show, so the machine-learning classifier 230 may increase the timer 234 from a 30 second countdown to a 45 second countdown. After timer 234 expires, media content 212 may be musical content, so the machine-learning classifier 230 may revert the timer 234 back to 30 seconds. As another example, if the type of content is an advertisement/commercial, the machine-learning classifier 230 may decrease the timer 234 from a 30 second countdown to a 5 second countdown. In some examples, the timer 234 may be set to “zero” and the communication channel associated with the identified type of content may be skipped automatically.

In some examples, the machine-learning classifier 230 may dynamically modify the list of the one or more communication channels according to a type of media being streamed on a media stream associated with a communication channel. As mentioned above, the machine-learning classifier 230 may identify the type of media associated with the media stream using the second machine-learning model. The second machine-learning model may be trained to interpret natural language and determine a type of content being streamed over a media stream (e.g., music, advertisements, talk radio, sporting event, etc.). In some examples, the list of the one or more communication channels may dynamically change according to the type of content associated with the respective media streams of each of the one or more communication channels.

For example, the media-streaming application 222 may be outputting the media stream of the first communication channel 214, and the second machine-learning model may identify the type of content associated with the media stream of the second communication channel 216 (assuming the second communication channel 216 is subsequent to the first communication channel 214 in the list of the one or more communication channels). If the type of content associated with the media stream of the second communication channel is an advertisement and/or commercial, the second machine-learning model may manipulate the list of the one or more communication channels by moving the second communication channel 216 further down the sequential order of the list (e.g., moving it from second to fifth). This manipulation is intended to prevent the user from hearing advertisements/commercials during the duration of the timer 234 while the second communication channel 216 is output by the media-streaming application 222. In another example, if the type of content associated with the media stream of the second communication channel is talk radio (e.g., during a morning talk radio segment that consists of talk and radio intermittently), when the user profile associated with the user device 204 indicates a preference for music, the second machine-learning model may manipulate the list of the one or more communication channels may moving the second communication channel 216 further down the sequential order of the list.

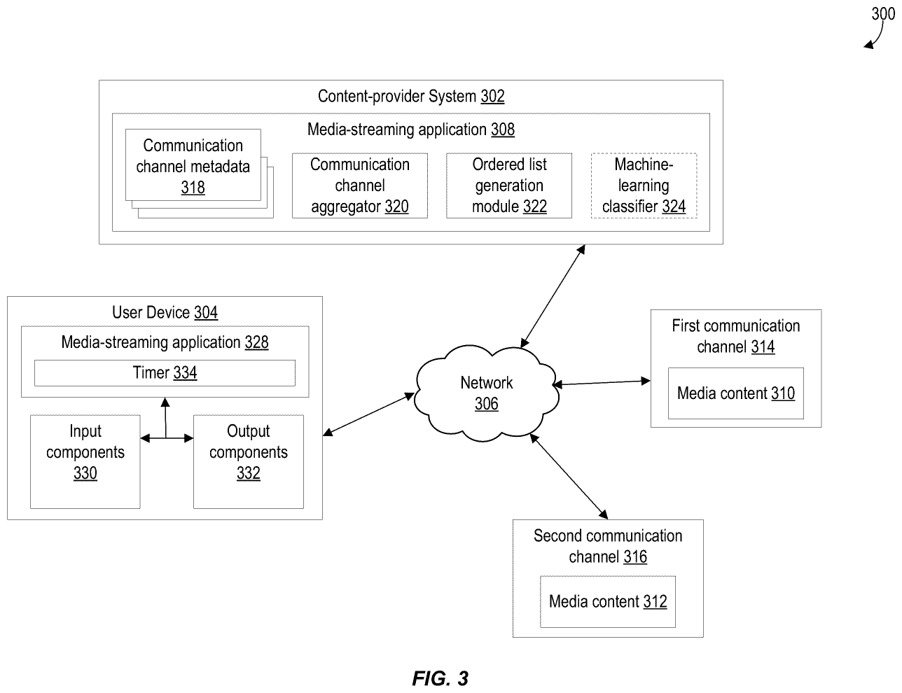

FIG. 3 illustrates an example computing environment for a content-provider system performing smart scan identification using machine-learning techniques according to aspects of the present disclosure. In FIG. 3, a content-provider system 302 may include hardware and/or software components that operate within a distributed environment to stream media content to one or more user devices (e.g., a user device 304, etc.) over a communication network 306. The content-provider system 202 can store and execute a server-side media-streaming application 308, which may be configured to stream media content 310 and 312 broadcasted from various communication channels (e.g., communication channels 314 and 316). To facilitate streaming of media content, the server-side media-streaming application 308 can access various data from the user device 304 (e.g., a computing device, an in-vehicle entertainment system, a mobile device, or the like). For example, the media-streaming application 308 can access past browsing history (e.g., web-browsing history, media-streaming application browsing history, etc.) of the user device 304 and user profile data of the user device 304 to identify a set of default communication channels for streaming media content to the user device 304. In some instances, when operating in a distributed environment, the content-provider system 302 may include executable processes in which some processes may be executed by the user device 304 and some processes may be executed by the content-provider system 302.

The media-streaming application 308 may receive media streams corresponding to the media content 312 and 310 (e.g., such as, but not limited to a radio broadcast) over the network 306 (e.g., a cloud network, a local area network, a wide area network, the Internet, etc.). The media streams may be transmitted or broadcasted by the communication channels 314 and 316 (e.g., physical location from which a media stream is broadcasted or transmitted such as, but not limited to, a radio station). The media-streaming application 308 can process the media streams to present the corresponding media content to the user device 304. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 302 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 308. The content-provider system 302 can also include one or more databases that store communication channel metadata 318 that include data for identifying media content broadcasted by a communication channel, a genre of the media content, a program schedule of content included in the media content, location of the communication channel, and/or the like.

In some instances, a communication channel aggregator 320 stores groups of communication channels that provide substantially similar media content. For example, the communication channel aggregator 320 stores a first group of communication channels that provide sports-news content, a second group of communication channels that provide classical-rock content, and the like. As the user device 304 selects a particular communication channel provided by the media-streaming application 308, a corresponding group of communication channels are presented together to allow the user to switch between different communication channels to access similar media content. The association between the communication channels can be predetermined by the content provider based on historical data from users that utilize the media-streaming application, locations at which the communication channels are broadcasted, etc. In some instances, the communication channels are grouped together by analyzing the respective metadata of the media streams. For example, the metadata from a particular media stream can identify that the communication channel is a classical music radio station based on San Francisco, which can be grouped with a communication channel in New York that broadcasts classical music.

In addition, the media-streaming application 308 of the content-provider system 302 can include an ordered-list generation module 322 and a machine-learning classifier 324, which can be used individually or in combination to facilitate smart scan sessions. For example, the ordered-list generation module 322 can request the machine-learning classifier 324 generates an ordered list. The ordered list may contain the first communication channel 314 and the second communication channel 316 and their respective media content (e.g., media content 310 and media content 312). The media content (e.g., media content 310 and media content 312) may be transmitted by a network (e.g., network 306) via a respective media stream. The respective media stream associated with the media content 310 and the media content 312 may be transmitted by the network 306 to the media-streaming application 308 for transmission to the user device 304 via the media-streaming application 328. The media stream may be audio and/or visual content. A media-streaming application 328 can be installed in the user device 304, in which the media-streaming application 328 provides an interface that facilitates streaming of the media content 310 broadcasted by the first communication channel 314. The media-streaming application 308 can access the media stream as the content is being broadcasted from the communication channel 314 to the user device 304.

The ordered-list generation module 322 can generate a list of one or more communication channels (e.g., first communication channel 314 and/or second communication channel 316) based on a set of data. The set of data may be associated with user device 304, and may include a user profile (e.g., demographic information, user preferences, age, geographic location, etc. of a user associated with user device 304), registered geolocation of the user device 304, current geolocation of the user device 304, geolocation of a broadcasting center associated with a communication channel, a communication channel history (e.g., listening frequency, listening habits, communication channel preferences, genre preferences, etc.), indications of one or more communication channels saved to the user profile (e.g., “saved” or “favorited” communication channels), popular communication channels (e.g., popular for a particular, age, region, genre, etc.), communication channel metadata 318, communication channel aggregator 320, any combination thereof, or the like. In some examples, the ordered-list generation module may select one or more communication channels according to the set of data. For example, the one or more algorithms may select one or more communication channels with the highest degree of similarity to the communication channel history, indications of one or more communication channels saved to the user profile, communication channels popular with a particular demographic or geographic region, etc. Similarity may be determined by matching characteristics of the selected communication channel (e.g., genre, artists, subject matter, broadcast location, etc.) to corresponding characteristics of communication channels stored in the channel history of a user device. A high degree of similarity may correspond with a predetermined quantity of matching characteristics. For example, if the user device frequently outputs communication channels associated with political talk radio, the ordered-list generation module 322 may select communication channels associated with political talk radio to input into the ordered list.

In some instances, the ordered-list generation module 322 can generate the list of one or more communication channels using a machine-learning classifier 324. The machine-learning classifier 324 may receive the set of data and may be trained to generate the list of one or more communication channels customized to the user device 304 using a first machine-learning model. Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. In some instances, the first machine-learning model may be trained using training data received and/or derived from media streams previously presented by the user device. In some examples, the first machine-learning model was trained using training data received and/or derived from prior lists of one or more communication channels. In some instances, the first machine-learning model may be trained using media streams associated other user devices (e.g., such as other devices executing the media-streaming application). The first machine-learning model can be trained using supervised training, supervised training, semi-supervised training, reinforcement training, combinations thereof, or the like.

For example, the first machine-learning model may be trained using transfer learning. Transfer learning is a technique in machine learning where a machine-learning model initially trained to solve a particular task is used as the starting point for a different task. Transfer learning can be useful when the second task is somewhat similar to the first task, or when there is limited training data available for the second task. For example, a machine-learning model initially trained to generate a list of similar communication channels may be further trained to generate a list of communication channels customized for a particular user device. In some instances, the machine-learning classifier 324 accesses a pre-trained model and “fine-tunes” the pre-trained model by training it on a second training dataset. The second training dataset can include training data that are labeled as either corresponding to musical content or non-musical content (e.g., talk radio). To further fine-tune the first machine-learning model, the machine-learning classifier 324 reconfigures the first machine-learning model to include additional hidden and/or output layers to recognize musical and/or non-musical content and dynamically adapting the timer 334 (e.g., playing a longer sample of talk radio and a shorter sample of musical radio before switching to the next communication channel). In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the first machine-learning model can include freezing the weights of the first machine-learning model, to train the first machine-learning model to predict interruptions in the media content. Then, the weights can be unfrozen such that the first machine-learning model can be trained to improve accuracy of the classification.

The machine-learning classifier 324 can also be configured to apply the first machine-learning model to the list of one or more communication channels to modify the list in real-time according to received user input (e.g., if the user continues to skip country music stations, the machine-learning model may remove country music stations from the list of one or more communication channels). In particular, the list of one or more communication channels may be updated in real-time as input is received on media-streaming application 328 through user device 304.

As described in FIG. 2, the media stream can additionally include other types of data. For example, the media stream can include metadata for use in identifying the media content 310 and/or the communication channel 314. The metadata may include, but is not limited to, an identification of a genre of the communication channel and/or current media content being presented, an identification of a song, an identification of an artist, an identification of an album, an identification of a media presentation (e.g., a concert, television show, movie, etc.), an identification of historical media streams (e.g., within a predetermined time interval such as past day, year, etc. or with any time interval), a communication channel (e.g., radio station), a location (e.g., a country, a state, a region, a city, an address, etc.), a context (e.g., such as a concept, emotion, an experience, and/or the like), or the like. In some examples, the media-streaming application 308 may identify that a communication channel is presenting a song, a talk-radio program, a local and/or national news program, an advertisement and/or commercial, a morning talk radio program, a sports talk program, a sporting event, a political program, a live event (e.g., the State of the Union Address, the Oscars, a live sporting event, etc.), etc.

In some examples, the media-streaming application 308 may request the machine-learning classifier 324 identify the type of media included in the media stream. A second machine-learning model may be trained to identify media associated with a media stream. In some instances, the second machine-learning model may use natural language interpretation to match words or phrases of media of broadcast channel to words and phrases stored in a reference database of known media. Alternatively, or additionally, the second machine-learning model may use frequency analysis, spectral analysis, pattern matching, and/or the like to match media of a broadcast channel to segments of media stored in a reference database of known media. The second machine-learning model may be trained in a manner similar to the first machine-learning model. In some examples, the first machine-learning model and the second machine-learning model may operate in conjunction with one another to implement commands from the machine-learning classifier 324 and/or the media-streaming application 308. The second machine-learning model may receive one or more elements of data as input, including, but not limited to, the metadata associated with the media stream mentioned above, data pertaining to the associated communication channel (e.g., location of the station, description associated with the communication channel, schedule associated with media content to be streamed on the communication channel, name of the communication channel, etc.), the media content associated with the media stream (e.g., audio and/or visual content), any combination thereof, or the like.

The user device 304 can include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 302 and present the media stream to provide media content for a user. The user device 304 also include a client-side media-streaming application 328, input components 330, and output components 323. The media-streaming application 328 can be configured to receive media streams transmitted by the content-provider system 302 and present media content from various communication channels. In some instances, the media-streaming application 328 can be configured to facilitate smart scan session and request an ordered list of one or more communication channels customized to the user device from media streaming application 308. In some instances, the media-streaming application 328 provides a timer 334. When the timer 334 expires, the user device 305 can transmit a request to the content-provider system to present the next sequential communication channel in the list of one or more communication channels. The timer 334 defines a duration of time (e.g., seconds, minutes, hours, etc.) that controls the connection to each communication channel of the ordered list of communication channels. The timer may be initiated when the media-streaming application 328 connects to the first communication channel 314. The expiration of the timer may cause the media-streaming application to establish a connection with a second communication channel 316 of the ordered list of one or more communication channels.

The media-streaming application 328 may present the media content associated with a communication channel in the list of one or more communication channels via user device 304. For example, the media-streaming application 328 may present the media content 310 from the first communication channel 314. Upon presentation, the media-streaming application 328 may initiate the timer 334. When the timer 334 expires, the media-streaming application 328 may begin presentation of the second communication channel 316 and associated media content 312. The timer 334 can be deactivated at any time via user input to prevent the media-streaming application from changing communication channels or causing the media-streaming application to switch to the next communication channel early (e.g., before termination of the timer 334). For example, the user can “skip” the first communication channel 314 if the user dislikes the media content 310 and may cause the second communication channel 316 to automatically be presented, regardless of the status of the timer 334. If the user opts to manually switch communication channels, the timer 334 may automatically reset upon presentation of a new communication channel. In some instances, the length of the timer may be configured by user input, the media-streaming application (e.g., based on default settings, historical user input, etc.), a machine-learning model, and/or the like prior to activation of the timer 334. The length of the timer may be any length of time such as, but not limited to, seconds, minutes, hours, etc.

The media-streaming application 328 may present the communication channels of the list of the one or more communication channels in sequential order. In some examples, media-streaming application 328 may select the communication channels of the list of the one or more communication channels for presentation randomly (e.g., using a random number generator, using a hash algorithm). As mentioned above, machine-learning classifier 324 may dynamically modify the list of the one or more communication channels in real-time according to feedback from the user device 304. The machine-learning classifier 324 may add communication channels, remove communication channels, modify the order of communication channels, modify the timer 334, according to input and/or feedback from the user device 304. For example, the machine-learning classifier 324 may detect that the user device 304 is presenting communication channels playing pop for longer durations (e.g., manually skipping other genres of communication channels) and may modify the list of the one or more communication channels by adding additional pop-genre communication channels, removing communication channels associated with other genres (e.g., country, rock, electronic, etc.), and/or initiating a longer timer 334 when presenting pop-genre communication channels (e.g., such that pop-genre communication channels are presented for longer duration of time than other communication channels, etc.). In some examples, the machine-learning classifier 324 may recognize the type of media of media content 310 (e.g., talk radio, music radio, long-format programming, etc.) and may modify the timer 334 automatically. For example, the media content 310 may be a morning talk radio show, so the machine-learning classifier 324 may increase the timer 334 from a 30 second countdown to a 45 second countdown. After timer 334 expires, media content 312 may be musical content, so the machine-learning classifier 324 may revert the timer 334 to 30 seconds. As another example, if the type of content is an advertisement/commercial, the machine-learning classifier 324 may decrease the timer 334 from a 30 second countdown to a 5 second countdown. In some examples, the timer 334 may be set to “zero” causing particular types of content may be skipped automatically.

In some examples, the machine-learning classifier 324 may dynamically modify the list of the one or more communication channels according to a type of media being streamed on a media stream associated with a communication channel. As mentioned above, the second machine-learning model of the machine-learning classifier 324 may identify the type of media presented by a communication channel or may identify the media. For example, the second machine-learning model may be trained to identify media or a media type (e.g., music, genre, advertisements, talk radio, sporting event, live event, etc.) using natural language processing (e.g., matching words or phrases within the media to known media or media types, etc.), frequency or spectral analysis, pattern matching, and/or the like. In some examples, the list of the one or more communication channels may dynamically change according to the media and/or media type that is currently being presented by the one or more communication channel.

For example, while the media-streaming application 328 is presenting the media stream of the first communication channel 314, and the second machine-learning model may identify a media type and/or the media of the media stream of the next communication channel (e.g., the communication channel 316) in the list of the one or more communication channels. If the type of content associated with the media stream of the second communication channel is an advertisement, the second machine-learning model may modify the list of the one or more communication channels by moving the second communication channel 316 further down the list (e.g., moving it from second to fifth, etc.). The modification prevents the user from being presented media that may not be representative of the media stream of the communication. In another example, if the media type and/or the media of the second communication channel is talk radio and the user profile associated with the user device 304 indicates a preference for music, the second machine-learning model may modify the list of the one or more communication channels by moving the second communication channel 116 further down the list.

To enable user interaction with the media-streaming application 328, the input components 330 can be utilized, which can include a microphone for speech, a touch-sensitive screen for gesture or graphical input, keyboard, mouse, motion input, pen, and other such input devices. In addition, the media content from the communication channel can be outputted using the output components 332, which can include, but not limited to, monitors, speakers, printers, haptic devices, and other such output devices. In some instances, the user device 304 interacts with the media-streaming application 328 through a user interface to identify communication channels and access their respective media streams. The user interface may display one or more user interface elements that identify the media content presented, being presented, and/or to be presented by the user device (e.g., the media content 310), as well as the communication channel corresponding to the media content (e.g., the first communication channel 314). The user input may be received using the input components 224 to select an icon that represents a communication channel, which triggers the media content to be presented on the user device 304 via the output components 326 (e.g., speaker, display screen).

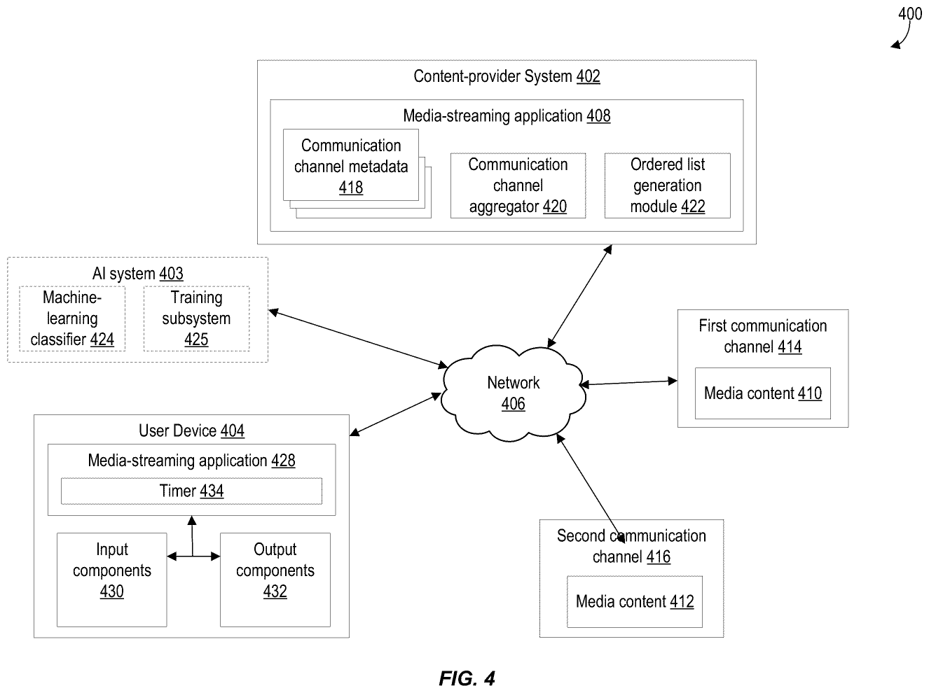

FIG. 4 illustrates an example computing environment for a content-provider system performing smart scan identification based on output generated from a special-purpose computer, according to some embodiments. In FIG. 4, a content-provider system 402 may include hardware and/or software components that operate within a distributed environment to stream media content to one or more user devices (e.g., a user device 404) over a communication network 406. The content-provider system 402 can store and execute a server-side media-streaming application 408, which may be configured to stream media content 410 and 412 broadcasted from various communication channels (e.g., first communication channel 414 and second communication channel 416). To facilitate streaming of media content, the server-side media-streaming application 408 can access various data from the user device 404 (e.g., a computing device, an in-vehicle entertainment system, a mobile device, or the like). For example, the media-streaming application 408 can access past browsing history (e.g., web-browsing history, media-streaming application browsing history, etc.) of the user device 404 and user profile data of the user device 404 to identify a set of default communication channels for streaming media content to the user device 404. In some instances, when operating in a distributed environment, the content-provider system 402 may include executable processes in which some processes may be executed by the user device 404 and some processes may be executed by the content-provider system 402.

The media-streaming application 408 may receive media streams broadcast by the first communication channel 414 and the second communication channel 416 over the network 406 (e.g., a cloud network, a local area network, a wide area network, the Internet, etc.). The media-streaming application 408 can process the media streams to present the corresponding media content to the user device 404. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 402 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 408. The content-provider system 402 can also include one or more database that store media-source metadata 418 that include data for identifying media content broadcasted by a communication channel, a genre of the media content, a program schedule of content included in the media content, location of the communication channel, and/or the like.

In some instances, a communication channel aggregator 420 stores groups of communication channels that provide substantially similar media content. For example, the communication channel aggregator 420 stores a first group of communication channels that provide sports-news content, a second group of communication channels that provide classical-rock content, and the like. As the user device 404 selects a particular music source provided by the media-streaming application 408, a corresponding group of communication channels are presented together to allow the user to switch between different communication channels associated with similar media content. The association between the communication channels can be predetermined by the content provider based on historical data, from users that utilize the media-streaming application, locations at which the communication channels are broadcasted, etc. In some instances, the communication channels can be grouped together by analyzing the respective metadata of the media streams.

In addition, the media-streaming application 408 of the content-provider system 402 can include an ordered-list generation module 422, which can be used individually or in combination to predict interruptions in various media content. For example, the ordered list generate module 422 can generate an ordered list of communication channels to be presented by the user device 404. The ordered list may contain the first communication channel 414 and the second communication channel 416 and their respective media content (e.g., media content 410 and 412). The media content (e.g., media content 410 and media content 412) may be transmitted by a network (e.g., network 406) via a respective media stream. The respective media stream associated with the media content 410 and 412 may be transmitted by the network 406 to the media-streaming application 428 for output by the user device 404. The media stream may include audio and/or visual content. A media-streaming application 428 can be installed in the user device 404, in which the media-streaming application 428 provides an interface that facilitates streaming of the media content 410 broadcasted by the first communication channel 414. The media-streaming application 408 can access the media stream of media content 410 as the music is being broadcasted from the communication channel 414 to the user device 404.

The ordered-list generation module 422 can generate a list of one or more communication channels (e.g., first communication channel 414 and/or second communication channel 416) based on a set of data. The set of data may be associated with user device 404, and may include, but is not limited to, a user profile (e.g., demographic information, user preferences, age, geographic location, etc. of a user associated with user device 404), geolocation of a broadcasting center associated with a communication channel, registered geolocation of the user device 404, current geolocation of the user device 404, a communication channel history (e.g., listening frequency, listening habits, communication channel preferences, genre preferences, etc.), indications of one or more communication channels saved to the user profile (e.g., “saved” or “favorited” communication channels), popular communication channels (e.g., popular for a particular, age, region, genre, etc.), communication channel metadata 418, communication channel aggregator 420, any combination thereof, or the like. In some examples, the ordered-list generation module 422 may select one or more communication channels according to the set of data. For example, the ordered-list generation module 422 may select one or more communication channels with a highest degree of similarity to the communication channel history, indications of one or more communication channels saved to the user profile, communication channels popular with a particular demographic or geographic region, etc. Similarity may be determined by matching characteristics of the selected communication channel (e.g., genre, artists, subject matter, broadcast location, etc.) to corresponding characteristics of communication channels stored in the channel history of a user device. A high degree of similarity may correspond with a predetermined quantity of matching characteristics. For example, if the user device frequently outputs communication channels associated with political talk radio, the ordered-list generation module 422 may select communication channels associated with political talk radio to input into the ordered list.

In some instances, the ordered-list generation module 422 can interact with the AI system 403 to generate the ordered list. In some embodiments, the AI system 403 is implemented by a special purpose computer that is specifically configured to generate customized ordered lists of one or more communication channels according to a set of data pertaining to user device 404. Additionally, one or more components of the AI system 403 is implemented by another special purpose computer (e.g., a training subsystem 425) that is specifically configured to train the machine-learning model using an amount of historical data and applying the trained machine-learning algorithms to generate ordered lists of one or more communication channels. The AI system 403 may receive a set of data and may train a first machine-learning model to generate a list of one or more communication channels customized to the user device 404.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. The training subsystem 425 of the AI system can be configured to train the first machine-learning model using training data received and/or derived from media streams previously presented by the user device 404. In some instances, the training subsystem 425 trains the first machine-learning model using media streams associated other user devices (e.g., such as other devices executing the media-streaming application). The training subsystem 425 can train the first machine-learning model using supervised training, supervised training, semi-supervised training, reinforcement training, combinations thereof, or the like.

For example, the training subsystem 425 can train the first machine-learning model using transfer learning. Transfer learning is a technique in machine learning where a machine-learning model initially trained by the training subsystem 425 to solve a particular task is used as the starting point for a different task. Transfer learning can be useful when the second task is somewhat similar to the first task, or when there is limited training data available for the second task. For example, a first machine-learning model initially trained to generate a list of similar communication channels may be further trained to generate a list of communication channels customized for a particular user device. In some instances, the machine-learning classifier 230 accesses a pre-trained model and “fine-tunes” the pre-trained model by training it on a second training dataset. The second training dataset can include training data that are labeled as either corresponding to musical content or non-musical content (e.g., talk radio). To further fine-tune the first machine-learning model, the machine-learning classifier 424 reconfigures the first machine-learning model to include additional hidden and/or output layers to recognize musical and/or non-musical content and dynamically adapting the timer 434 (e.g., playing a longer sample of talk radio and a shorter sample of musical radio before switching to the next communication channel). In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the first machine-learning model can include freezing the weights of the first machine-learning model, to train the first machine-learning model to predict interruptions in the media content. Then, the weights can be unfrozen such that the first machine-learning model can be trained to improve accuracy of the classification.

The machine-learning classifier 424 can also be configured to apply the first machine-learning model to the list of one or more communication channels to modify the list in real-time according to received user input (e.g., if the user continues to skip country music stations, the machine-learning model may remove country music stations from the list of one or more communication channels) or the properties of the user device 404 or the user thereof (e.g., such as, but not limited to, a real-time geolocation of the user device, etc.). In particular, the list of one or more communication channels may be updated in real-time as input is received on media-streaming application 428 through user device 404.

As described in FIG. 2, the media stream can additionally include other types of data. For example, the media stream can include metadata for use in identifying the media content 410 and/or the first communication channel 414. Metadata may include, but is not limited to, an identification of a genre of the communication channel and/or current media content being presented, an identification of a song, an identification of an artist, an identification of an album, an identification of a media presentation (e.g., a concert, television show, movie, etc.), an identification of historical media streams (e.g., within a predetermined time interval such as past day, year, etc. or with any time interval), a communication channel (e.g., radio station, etc.), a location (e.g., a country, a state, a region, a city, an address, etc., a context (e.g., such as a concept, emotion, an experience, and/or the like), or the like. In some examples, the media-streaming application 408 may identify the type of media content included in the media stream. For example, the media-streaming application 408 may identify that a communication channel is streaming a song, a talk-radio program, a local and/or national news program, an advertisement and/or commercial, a morning talk radio program, a sports talk program, a sporting event, a political program, a stream of a live event (e.g., the State of the Union Address, the Oscars, a live sporting event, etc.), etc.

In some examples, the media-streaming application 408 may request the AI system 403 identify the type of media included in the media stream and/or the media content (e.g., an identifier of a particular song, live event, program, etc.). A second machine-learning model may be trained to identify media associated with a media stream. In some instances, the second machine-learning model may use natural language interpretation to match words or phrases of media of broadcast channel to words and phrases stored in a reference database of known media. Alternatively, or additionally, the second machine-learning model may use frequency analysis, spectral analysis, pattern matching, and/or the like to match media of a broadcast channel to segments of media stored in a reference database of known media. The second machine-learning model may be trained in a manner similar to the first machine-learning model. In some examples, the first machine-learning model and the second machine-learning model may operate in conjunction with one another to implement commands from the AI system 403 and/or the media-streaming application 408. The second machine-learning model may receive data, including, but not limited to, the metadata associated with the media stream mentioned above, data pertaining to the associated communication channel (e.g., location of the station, description associated with the communication channel, schedule associated with media content to be streamed on the communication channel, name of the communication channel, etc.), the media content associated with the media stream (e.g., audio and/or visual content), any combination thereof, or the like.

The user device 404 can include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 402 and present the media stream to provide media content for a user. The user device 404 also include a client-side media-streaming application 428, input components 430, and output components 423. The media-streaming application 428 can be receive media stream transmitted by the content-provider system 402 and present media content from various communication channels. The media-streaming application 428 can be configured to facilitate smart scan sessions and generate an ordered list of one or more communication channels customized to the user device. To enable user interaction with the media-streaming application 222, the input components 224 can be utilized, which can include a microphone for speech, a touch-sensitive screen for gesture or graphical input, keyboard, mouse, motion input, pen, and other such input devices. In addition, the media content from communication channels can be output using the output components 226, which can include, but not limited to, monitors, speakers, printers, haptic devices, and other such output devices.

In some instances, the user device 404 interacts with the media-streaming application 428 through a user interface to identify communication channels and access their respective media streams. The user interface may display one or more user interface elements that identify the media content presented, being presented, and/or to be presented by the user device (e.g., media content 410), as well as the communication channel corresponding to the media content (e.g., first communication channel 414). The user input may be received using the input components 430 to select an icon that represents a communication channel, which triggers the media content to be presented on the user device 404 via the output components 423 (e.g., speaker, display screen).

In some instances, the media-streaming application 428 provides a timer 434. The timer 434 defines a duration of time (e.g., seconds, minutes, hours, etc.) that controls the connection to each communication channel of the ordered list of communication channels. The timer may be initiated when the media-streaming application 428 connects to the first communication channel 414. The expiration of the timer may cause the media-streaming application to establish a connection with a second communication channel 416 of the ordered list of one or more communication channels. Additionally, or alternatively, the timer 434 can be deactivated by the user manually opting for second communication channel 416 to be presented without waiting for the expiration of the timer 434. For example, the user can “skip” the first communication channel 414 if the user dislikes media content 410 and second communication channel 416 may automatically be presented, regardless of the status of the timer 434. If the user opts to manually switch communication channels, the timer 434 may automatically reset upon presentation of a new communication channel. In some instances, the length of the timer may be configured by user input, the media-streaming application (e.g., based on default settings, historical user input, etc.), a machine-learning model, and/or the like prior to activation of the timer 434. The length of the timer may be any length of time such as, but not limited to, seconds, minutes, hours, etc.

In some examples, media-streaming application 428 may present the communication channels of the list of the one or more communication channels in sequential order. In some examples, media-streaming application 428 may select the communication channels of the list of the one or more communication channels for presentation randomly (e.g., using a random number generator, using a hash algorithm, etc.). As mentioned above, AI system 403 may dynamically modify the list of the one or more communication channels according to feedback from the user device 404. The AI system 403 may add communication channels, remove communication channels, modify the order of communication channels, modify the timer 434, according to input and/or feedback from the user device 404. For example, the AI system 403 may detect that the user device 404 is presenting communication channels playing pop for longer durations (e.g., manually skipping all other genres of communication channels) and may modify the list of the one or more communication channels by adding additional pop-genre communication channels and/or removing communication channels associated with other genres (e.g., country, rock, electronic, etc.). In some examples, the AI system 403 may recognize the type of content of media content 410 (e.g., talk radio, music radio, long-format programming, etc.) and may modify the timer 434 automatically. For example, the media content 410 may be a morning talk radio show, so the AI system 403 may increase the timer 434 from a 30 second countdown to a 45 second countdown. After timer 434 expires, media content 412 may be musical content, so the AI system 403 may revert the timer 434 to 30 second. As another example, if the type of content is an advertisement/commercial, the AI system 403 may decrease the timer 434 from a 30 second countdown to a 5 second countdown. In some examples, the timer 434 may be set to “zero” and the communication channel associated with the identified type of content may be skipped automatically.

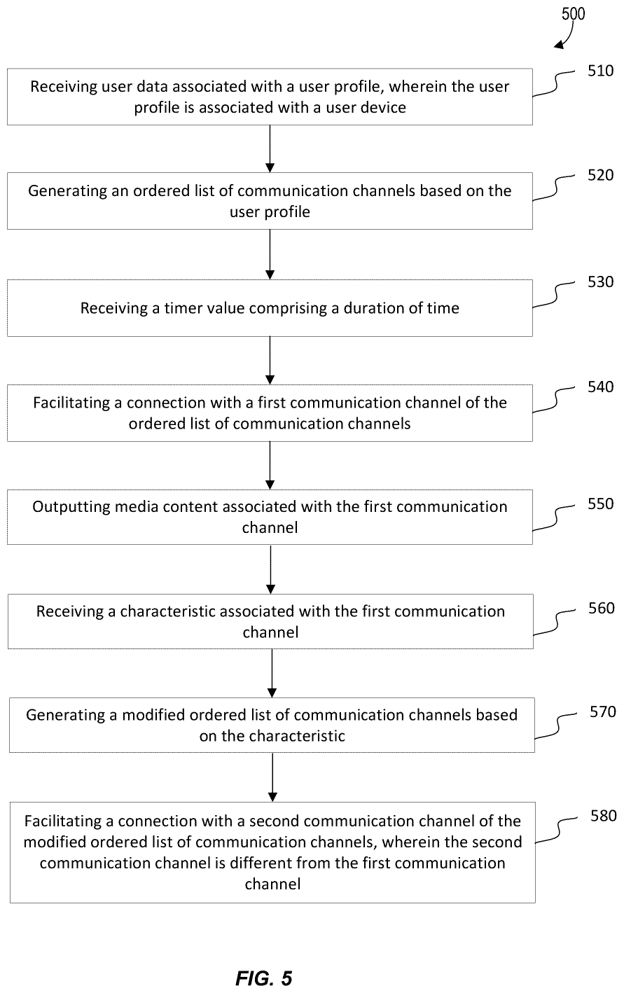

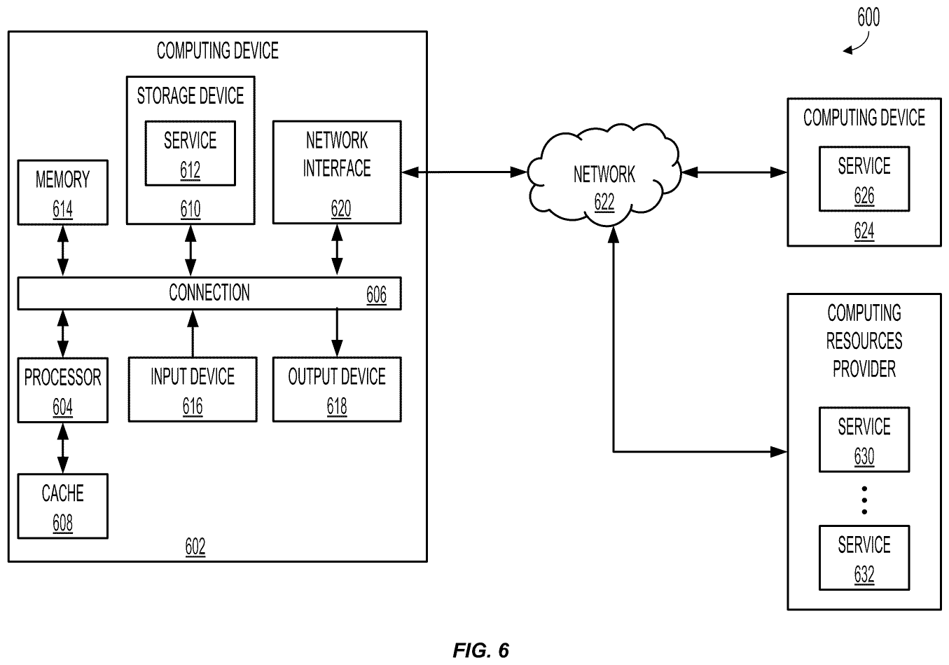

FIG. 5 illustrates an example process 500 for performing smart scan identification according to aspects of the present disclosure. For illustrative purposes, the process 500 is described with reference to the components illustrated in FIGS. 2-4, though other implementations are possible. For example, the instructions of the media-streaming application of FIGS. 2-4 may be executed by one or more processing devices to cause a server system (e.g., the computing device 602 of FIG. 6) to perform one or more operations described herein.

At block 510, a computing device may receive user data associated with a user profile, wherein the user profile is associated with a user device. For example, a computing device (e.g., a user device 102 of FIG. 1, in vehicle entertainment system, desktop or laptop computer, mobile device, etc.) may execute a media-streaming application that includes a user profile. The user profile may store user data associated with the media streaming application such as, but not limited to user device data, demographic data, localized data, historical data, indications of one or more communication channels saved to the user profile (e.g., “saved” or “favorited” communication channels), location information, any combination thereof, or the like. The user data may also be comprised of data pertaining to a communication channel history associated with the user device (e.g., an indication of a frequency that the media streaming application connects to communication channels, an identification of communication channels has connected to over a previous time interval, communication channel preferences, genre preferences, etc.), an identification of popular communication channels (e.g., according to metrics of the media-streaming application segmented according to particular groups such as age of user, geolocation of user, genre of music, demographic of user, etc.), communication channel metadata (e.g., the communication channel metadata 218 as described in FIG. 2), data from a communication channel aggregator (e.g., the communication channel aggregator 220 as described in FIG. 2), any combination thereof, or the like.

At block 520, the computing device may generate an ordered list of communication channels based on the user data. For example, the computing device may use ordered-list generation module 228 of FIG. 2 to generate the ordered list of communication channels according to user data. For example, the one or more algorithms may select one or more communication channels with the highest degree of similarity to the communication channel history, indications of one or more communication channels saved to the user profile, communication channels popular with a particular demographic or geographic region, etc. Similarity may be determined by matching characteristics of the selected communication channel (e.g., genre, artists, subject matter, broadcast location, etc.) to corresponding characteristics of communication channels stored in the channel history of a user device. A high degree of similarity may correspond with a predetermined quantity of matching characteristics.

In some examples, the computing device may use a machine-learning model (e.g., such as the machine-learning classifier 230 as described in FIG. 2 or any of the previously described machine-learning models) trained to generate custom lists of communication channels according to user data. The machine-learning model may include, but is not limited to, k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. For example, the machine-learning model may receive the user data and may infer a user's preferences from the user data, thereby generating a custom ordered list of one or more communication channels tailored to the preferences of a particular user (e.g., the ordered list contains communication channels that may be associated with a particular genre of music, political talk show, comedic programming, etc. based on the user data). In some examples, the machine-learning models may include popular communication channels, as previously described, according to the user's demographic and/or geographic location in the ordered list of one or more communication channels.

At block 530, the computing device may receive a timer value indicating a duration of time. The duration of time may indicate the amount of time a media streaming application presents media content associated with a communication channel of the ordered list of one or more communication channels. In some examples, the timer value may be a numerical value the correspond to any duration of time such as any quantity of seconds, minutes, hours, etc. In some examples, the timer value may be disabled or set to “off” such that the media streaming application may continue to present media content associated with a communication channel until receiving additional input.

At block 540, the computing device may facilitate a connection with a first communication channel of the ordered list of communication channels. A communication channel may transmit media content via a corresponding media stream. The media-streaming application may receive media streams corresponding to the ordered list of the one or more communication channels over a network (e.g., the network 206 described in FIG. 2). The media streams may be transmitted or broadcasted by a communication channel. The media-streaming application can process the media streams to present the corresponding media content to the user device. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

At block 550, the computing device may output media content associated with the first communication channel. The media-streaming application may present media content associated with a first communication channel in the ordered list of the one or more communication channels via the user device. Upon presentation, the media-streaming application may initiate a timer defined by the timer value.

At block 560, the computing device may receive a characteristic associated with the first communication channel. The characteristic may be based on the media content associated with the first communication channel (e.g., a music genre, a host name, a content type, a sport, a geographic region, a language, etc.), the user device (e.g., input indicating a user has “skipped” the first communication channel, a listening history of the user device, a user profile associated with the user device, a current time associated with the geographic location of the user device, a geographic location associated with the user device, etc.), any combination thereof, or the like.

At block 570, the computing device may generate a modified ordered list of communication channels based on the characteristic. In some examples, the modified ordered list may be the same as the original ordered list, indicating that the characteristic received from the first communication channel may reach a threshold significance to modify the original ordered list. The modified ordered list may be a modification of the original ordered list, such that the modified ordered list may include a different sequential order from the original ordered list, include a different quantity of communication channels from the original ordered list (e.g., such as fewer or more), include a modified duration of time that a communication channel is presented to the user device, any combination thereof, or the like.

In some other examples, a machine-learning model may be used to generate the modified ordered list based on the characteristic and the original ordered list. The machine-learning model may add communication channels, remove communication channels, modify the order of the communication channels, modify, or terminate the timer, etc. according to feedback, the characteristic, and/or input from the user device. For example, the machine-learning model may receive data indicating that the user device is presenting communication channels playing pop music for longer durations (e.g., manually skipping all other genres of communication channels) than other communication channels. The machine-learning model may modify the list of the one or more communication channels by adding additional pop-genre communication channels and/or removing communication channels associated with other genres (e.g., country, rock, electronic, etc.). In some examples, the machine-learning model may recognize the type of media of media content (e.g., talk radio, music radio, long-format programming, etc.) and may modify the timer automatically. For example, the media content may be a morning talk radio show, so the machine-learning model may increase the timer from a 30 sec. countdown to a 45 sec. countdown. After the timer expires, the next media content may be musical content, so the machine-learning model may revert the timer to 30 sec.

At block 580, the computing device may facilitate a connection with a second communication channel of the modified ordered list of communication channels, where the second communication channel is different from the first communication channel. When the timer expires, the media-streaming application may begin presentation of a second communication channel and associated media content. For example, the computing device may output media content of a first communication channel of the ordered list of communication channels. Upon termination of the duration of time, the computing device may connect to the next communication channel in the modified ordered list and/or the ordered list of communication channels and begin output media of the next communication channel. Additionally, the next communication channel may be immediately subsequent to the first communication channel in the ordered list of one or more communication channels.

Additionally, or alternatively, the timer can be deactivated by the user input causing the second communication channel to be presented without waiting for the expiration of the timer. For example, a communication channel can be “skipped” and the next communication channel may automatically be presented, regardless of the status of the timer. The timer may reset upon presentation of the next communication channel. In some examples, the media-streaming application may present the communication channels of the list of the one or more communication channels in sequential order. In some examples, the media-streaming application may select the communication channels of the list of one or more communication channels for presentation out-of-order such as, randomly (e.g., using a random number generator, a hash algorithm, etc.), based on an identification of skipped communication channels, a contemporaneous geolocation of the computing device, combinations thereof, or the like.

FIG. 6 illustrates a computing system architecture 600, including various components in electrical communication with each other, in accordance with some embodiments. The example computing system architecture 600 illustrated in FIG. 6 includes a computing device 602, which has various components in electrical communication with each other using a connection 606, such as a bus, in accordance with some implementations. The example computing system architecture 600 includes a processing unit 604 that is in electrical communication with various system components, using the connection 606, and including the system memory 614. In some embodiments, the system memory 614 includes read-only memory (ROM), random-access memory (RAM), and other such memory technologies including, but not limited to, those described herein. In some embodiments, the example computing system architecture 600 includes a cache 608 of high-speed memory connected directly with, in close proximity to, or integrated as part of the processor 604. The system architecture 600 can copy data from the memory 614 and/or the storage device 610 to the cache 608 for quick access by the processor 604. In this way, the cache 608 can provide a performance boost that decreases or eliminates processor delays in the processor 604 due to waiting for data. Using modules, methods, and services such as those described herein, the processor 604 can be configured to perform various actions. In some embodiments, the cache 608 may include multiple types of cache including, for example, level one (L1) and level two (L2) cache. The memory 614 may be referred to herein as system memory or computer system memory. The memory 614 may include, at various times, elements of an operating system, one or more applications, data associated with the operating system or the one or more applications, or other such data associated with the computing device 602.

Other system memory 614 can be available for use as well. The memory 614 can include multiple different types of memory with different performance characteristics. The processor 604 can include any general-purpose processor and one or more hardware or software services, such as service 612 stored in storage device 610, configured to control the processor 604 as well as a special-purpose processor where software instructions are incorporated into the actual processor design. The processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 604 can be a microprocessor, a microcontroller, a digital signal processor (“DSP”), or a combination of these and/or other types of processors. In some embodiments, the processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 600, an input device 616 can represent any number of input mechanisms, such as a microphone for speech, a touch-sensitive screen for gesture or graphical input, keyboard, mouse, motion input, pen, and other such input devices. An output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 600. In some embodiments, the input device 616 and/or the output device 618 can be coupled to the computing device 602 using a remote connection device such as, for example, a communication interface such as the network interface 620 described herein. In such embodiments, the communication interface can govern and manage the input and output received from the attached input device 616 and/or output device 618. As may be contemplated, there is no restriction on operating on any particular hardware arrangement and accordingly the basic features here may easily be substituted for other hardware, software, or firmware arrangements as they are developed.

In some embodiments, the storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 610 can include hardware and/or software services such as service 612 that can control or configure the processor 604 to perform one or more functions including, but not limited to, the methods, processes, functions, systems, and services described herein in various embodiments. In some embodiments, the hardware or software services can be implemented as modules. As illustrated in example computing system architecture 600, the storage device 610 can be connected to other parts of the computing device 602 using the system connection 606. In some embodiments, a hardware service or hardware module such as service 612, that performs a function can include a software component stored in a non-transitory computer-readable medium that, in connection with the necessary hardware components, such as the processor 604, connection 606, cache 608, storage device 610, memory 614, input device 616, output device 618, and so forth, can carry out the functions such as those described herein.

The disclosed systems and service of a media-streaming application (e.g., the media-streaming application 222 described herein at least in connection with FIG. 2) can be performed using a computing system such as the example computing system illustrated in FIG. 6, using one or more components of the example computing system architecture 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for generating proposals associated with a media-streaming application (e.g., the media-streaming application 222 described herein at least in connection with FIG. 2) described herein by, for example, executing code using a processor such as processor 604 wherein the code is stored in memory such as memory 614 as described herein. One or more of a user device, a provider server or system, a database system, or other such devices, services, or systems may include some or all of the components of the computing system such as the example computing system illustrated in FIG. 6, using one or more components of the example computing system architecture 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 614 can be coupled to the processor 604 by, for example, a connector such as connector 606, or a bus. As used herein, a connector or bus such as connector 606 is a communications system that transfers data between components within the computing device 602 and may, in some embodiments, be used to transfer data between computing devices. The connector 606 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 614 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connector 606 (or bus) can also couple the processor 604 to the storage device 610, which may include non-volatile memory or storage, and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 606 can also couple the processor 604 to a network interface device such as the network interface 620. The interface can include one or more of a modem or other such network interfaces including, but not limited to those described herein. It will be appreciated that the network interface 620 may be considered to be part of the computing device 602 or may be separate from the computing device 602. The network interface 620 can include one or more of an analog modem, Integrated Services Digital Network (ISDN) modem, cable modem, token ring interface, satellite transmission interface, or other interfaces for coupling a computer system to other computer systems. In some embodiments, the network interface 620 can include one or more input and/or output (I/O) devices. The I/O devices can include, by way of example but not limitation, input devices such as input device 616 and/or output devices such as output device 618. For example, the network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 602 can be connected to one or more additional computing devices such as computing device 624 via a network 622 using a connection such as the network interface 620. In such embodiments, the computing device 624 may execute one or more services 626 to perform one or more functions under the control of, or on behalf of, programs and/or services operating on computing device 602. In some embodiments, a computing device such as computing device 624 may include one or more of the types of components as described in connection with computing device 602 including, but not limited to, a processor such as processor 604, a connection such as connection 606, a cache such as cache 608, a storage device such as storage device 610, memory such as memory 614, an input device such as input device 616, and an output device such as output device 618. In such embodiments, the computing device 624 can carry out the functions such as those described herein in connection with computing device 602. In some embodiments, the computing device 602 can be connected to a plurality of computing devices such as computing device 624, each of which may also be connected to a plurality of computing devices such as computing device 624. Such an embodiment may be referred to herein as a distributed computing environment.

The network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 622, within the computing device 602, within the computing device 624, or within the computing resources provider 628 can include information, which also may be referred to herein as content. The information may include text, graphics, audio, video, haptics, and/or any other information that can be provided to a user of the computing device such as the computing device 602. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 602 and presented to a user of the computing device 602 using forms that are perceptible via sight, sound, smell, taste, touch, or other such mechanisms. In some embodiments, communications over the network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 602 and/or the computing device 624 can be connected to a computing resources provider 628 via the network 622 using a network interface such as those described herein (e.g., network interface 620). In such embodiments, one or more systems (e.g., service 630 and service 632) hosted within the computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, the computing resources provider 628 may provide a service, operating on service 630 to store data for the computing device 602 when, for example, the amount of data that the computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to the computing device 602. Such operations (e.g., data storage and VM instantiation) may be referred to herein as operating “in the cloud,” “within a cloud computing environment,” or “within a hosted virtual machine environment,” and the computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the service 626) on behalf of, or under the control of, computing device 602 and/or computing device 624. Such implemented versions of various services may involve one or more virtualization techniques so that, for example, it may appear to a user of computing device 602 that the service 612 is executing on the computing device 602 when the service is executing on, for example, service 630. As may also be contemplated, the various services operating within the computing resources provider 628 environment may be distributed among various systems within the environment as well as partially distributed onto computing device 624 and/or computing device 602.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).
Example 1 is a computer-implemented method, comprising: receiving user data associated with a user profile, wherein the user profile is associated with a user device; generating an ordered list of communication channels based on the user profile; receiving, from the user device, a timer value comprising a duration of time; facilitating a connection with a first communication channel of the ordered list of communication channels; outputting media content associated with the first communication channel; receiving a characteristic associated with the first communication channel; generating a modified ordered list of communication channels based on the characteristic; and facilitating a connection with a second communication channel of the modified ordered list of communication channels, wherein the second communication channel is different from the first communication channel.
Example 2 is the computer-implemented method of example(s) 1, further comprising: receiving user input from the user device, wherein the user input causes the output of the media content associated with the second communication channel.
Example 3 is the computer-implemented method of example(s) 1-2, wherein the ordered list is generated by a machine-learning model.
Example 4 is the computer-implemented method of example(s) 1-3, wherein the machine-learning model generates the ordered list further based on a communication channel history associated with the user device.
Example 5 is the computer-implemented method of example(s) 1-4, wherein the user profile comprises at least one of demographic data, communication channel history, and user preferences.
Example 6 is the computer-implemented method of example(s) 1-5, wherein the machine-learning model was trained using transfer learning.
Example 7 is the computer-implemented method of example(s) 1-6, wherein the first media source is associated with media content that is of the same type as media content associated with the second media source.
Example 8 is the computer-implemented method of example(s) 1-7, wherein an identification of the first communication channel is stored within the user profile.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 602) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory, or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 500 of FIG. 5). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving user data associated with a user profile, wherein the user profile is associated with a user device;
generating an ordered list of communication channels based on the user profile;
receiving a timer value including a duration of time;
facilitating a connection with a first communication channel of the ordered list of communication channels;
outputting media content associated with the first communication channel;
receiving a characteristic associated with the first communication channel;
generating a modified ordered list of communication channels based on the characteristic; and
facilitating a connection with a second communication channel of the modified ordered list of communication channels, wherein the second communication channel is different from the first communication channel.

1. The computer-implemented method of claim 1, further comprising:
receiving user input from the user device, wherein the user input causes the output of the media content associated with the second communication channel.

2. The computer-implemented method of claim 1, wherein the ordered list is generated by a machine-learning model.

3. The computer-implemented method of claim 3, wherein the machine-learning model generates the ordered list further based on a communication channel history associated with the user device.

4. The computer-implemented method of claim 3, wherein the machine-learning model was trained using transfer learning.

5. The computer-implemented method of claim 1, wherein the user profile comprises at least one of demographic data, communication channel history, or user preferences.

6. The computer-implemented method of claim 1, wherein the first communication channel is associated with media content that is of a same type as media content associated with the second communication channel.

7. The computer-implemented method of claim 1, wherein an identification of the first communication channel is stored within the user profile.

9. A system comprising:
one or more processors; and
a non-transitory computer-readable medium storing instructions that, when executed by the one or more processors, cause the one or more processors to:
receive user data associated with a user profile, wherein the user profile is associated with a user device;
generate an ordered list of communication channels based on the user profile;
receive a timer value including a duration of time;
facilitate a connection with a first communication channel of the ordered list of communication channels;
output media content associated with the first communication channel;
receive a characteristic associated with the first communication channel;
generate a modified ordered list of communication channels based on the characteristic; and
facilitate a connection with a second communication channel of the modified ordered list of communication channels, wherein the second communication channel is different from the first communication channel.

10. The system of claim 9, wherein the instructions further cause the one or more processors to:
receive user input from the user device, wherein the user input causes the output of the media content associated with the second communication channel.

11. The system of claim 9, wherein the ordered list is generated by a machine-learning model.

12. The system of claim 11, wherein the machine-learning model generates the ordered list further based on a communication channel history associated with the user device.

13. The system of claim 11, wherein the machine-learning model was trained using transfer learning.

14. The system of claim 9, wherein the user profile comprises at least one of demographic data, communication channel history, or user preferences.

15. The system of claim 9, wherein the first communication channel is associated with media content that is of a same type as media content associated with the second communication channel.

16. The system of claim 9, wherein an identification of the first communication channel is stored within the user profile.

17. A non-transitory computer-readable medium storing instructions that when executed by one or more processors cause the one or more processors to:
receive user data associated with a user profile, wherein the user profile is associated with a user device;
generate an ordered list of communication channels based on the user profile;
receive a timer value including a duration of time;
facilitate a connection with a first communication channel of the ordered list of communication channels;
output media content associated with the first communication channel;
receive a characteristic associated with the first communication channel;
generate a modified ordered list of communication channels based on the characteristic; and
facilitate a connection with a second communication channel of the modified ordered list of communication channels, wherein the second communication channel is different from the first communication channel.

18. The non-transitory computer-readable medium of claim 17, wherein the instructions further cause the one or more processors to:
receive user input from the user device, wherein the user input causes the output of the media content associated with the second communication channel.

19. The non-transitory computer-readable medium of claim 17, wherein the ordered list is generated by a machine-learning model.

20. The non-transitory computer-readable medium of claim 19, wherein the machine-learning model generates the ordered list further based on a communication channel history associated with the user device.
